(19) United States
(12) Patent Application Publication
(10) Pub. No.: US 2005/0183740 A1
(43) Pub. Date: Aug. 25, 2005

(54) Process and apparatus for removing residues from semiconductor substrates

(76) Inventors: John L. Fulton, Richland, WA (US); Daniel J. Gaspar, Richland, WA (US); Clement R. Yonker, Kennewick, WA (US); James S. Young, Pasco, WA (US); Alan Scott Lea, Richland, WA (US); Mark H. Engelhard, Richland, WA (US)

Correspondence Address: BATTELLE MEMORIAL INSTITUTE;ATTN: IP SERVICES, K1-53, P. O. BOX 999, RICHLAND, WA, 99352, US

(21) Appl. No.: 10/783,249

(22) Filed: Feb. 19, 2004

(51) Int. Cl. B08B 3/00

(52) U.S. Cl. 134/3; 134/4; 134/36; 134/200

(57) ABSTRACT

The present invention generally relates to a system for cleaning substrates. More particularly, the present invention relates to process(es) for effecting chemical removal of residues from semiconductor substrates, including silicon wafers, using a system of reactive reverse micelle(s) or microemulsions in a densified carbon dioxide matrix. Various reactive chemical agents in the reactive micelle system may be used to effect cleaning and removal of etch and metal residues to levels sufficient for commercial wafer production and processing.

### FIELD OF THE INVENTION

The present invention generally relates to a process and apparatus for cleaning substrates. More particularly, the present invention relates to processes for removing residues including etch, metal, and non-metal residues from semiconductor substrates. The instant invention finds application in many processes such as commercial silicon wafer production.

### BACKGROUND

The semiconductor industry faces challenges to produce devices with increasingly smaller features to increase electrical component density per unit area on a wafer and to enhance operating speed of the semiconductor. Electrical components of semiconductor devices are now approaching sizes and/or dimensions such that surface tension generated by conventional aqueous and semi-aqueous cleaning solutions during manufacturing may damage the extremely delicate electrical components and/or features. Ultimately the surface tension exerted in these liquids on the small wafer surface features and patterns will exceed the critical stress, the point of structural failure, making conventional aqueous and semi-aqueous fluids unsuitable or at worst obsolete for next-generation processing and cleaning of substrates, wafers, and/or semiconductors. New cleaning fluids and approaches or processes that address the fundamental surface tension limitation that remain reactive toward tenacious surface residues are needed. The term “tenacious residues” describes the typically high molecular weight and heterogenous residues comprising combinations of metallic and/or non-metallic residues introduced to a substrate surface during wafer processing (e.g., plasma etching) and which become partially or fully polymerized or bound to a polymer matrix or are otherwise physically trapped or confined within a bulk residue.

The substrates in semiconductor or wafer processing are conventionally multilayered composites comprising silicon and other thinly layered and/or deposited materials or films. During wafer processing and production, various and dynamic combinations of etch and/or metal residues are routinely sputtered and deposited onto a surface in, on, or around the macro and micro structures or patterns located thereon. For example, metal residues including copper (Cu), aluminum (Al), and iron (Fe) or other transition metal residues, as well as non-metal residues including carbon (C), nitrogen (N), oxygen (O), phosphorus (P), sulfur (S), or others (F, Cl, I, Si,) may be deposited on a surface on various patterned structures (i.e., vias) in the form of particulates, crumbs, mounds, striations, films, and molecular layers. Presence of such residues following processing may lead to a faulty or failed device. Thus, commercial production requires residues to be removed from the wafer.

Densified fluids including near-critical and supercritical fluids can address the fundamental surface tension limitation associated with aqueous and semiaqueous fluids without risking structural collapse of features. However, a major drawback of densified fluid systems is that they are non-reactive, having no ability to directly chemically modify and remove tenacious metal and non-metal residues generated during wafer processing.

Accordingly, there remains a need to show an effective system for removing tenacious residues from semiconductor substrates and/or surfaces that addresses critical surface tension limitations. We present a “reactive” system wherein 1) removal of tenacious residues is effected; 2) surface tension approaches zero as compared to aqueous and semi-aqueous fluid systems known in the art; 3) risk of damage to, or structural collapse of, intricate substrate features is minimized; 4) polarity in the continuous phase is maintained; and 5) speed of cleaning is enhanced. The present invention thus represents a new advancement relative to wafer and semiconductor surface processing.

### SUMMARY OF THE INVENTION

The present invention relates to a “reactive” system and process for effecting removal of tenacious residues found on substrates and surfaces such as a semiconductor (e.g., silicon) surface. Residues may include, but are not limited to, the group of organic residues, metal residues, etch residues, non-metal residues, polymeric residues, and combinations thereof. The term “reactive” in reference to the systems of the present invention describes chemical processes or reactions wherein combinations of chemically reactive agents or constituents present in the densified fluid and/or reverse micelle core react with and chemically modify residues thereby effecting removal from the substrate or surface. Reactions effecting residue removal may include, but are not limited to, the group of chemical, oxidation, reduction, molecular-weight reduction, fragment cracking, exchange, association, dissociation, complexation (including polar head group reactions within the inner polar cores of the reactive reverse micelles or aggregates), and combinations thereof.

The reactive systems of the present invention are distinguished from other densified fluid cleaning systems known in the art in at least the following key areas. First, the present invention embodies reactive approaches for effecting residue removal and/or cleaning that are viable and applicable to commercial wafer and/or semiconductor processing. Test results show, for example, that residue removal is effected to industry accepted contamination standards or better. One such measure for commercial processing is the atomic monolayer standard for residue per unit area. For example, a monolayer of pure silicon on a wafer surface may be calculated to comprise a coverage of approximately 2×10¹⁵ atoms per square centimeter (e.g., atoms/cm²). The systems of the present invention have been shown to remove residues to a level of about 4×10¹¹ atoms/cm² or better, making them ultimately viable for commercial use. Secondly, systems of the present invention offer enhanced speeds and/or efficiencies for effecting removal of residues. For example, residue removal occurs in a maximum period up to 15 minutes. Typical periods for residue removal occur in 5 minutes or less on average. Periods of 15 seconds are presently ideal. Thirdly, and significantly, the systems embodied in the present invention exert low surface tension stresses on small wafer features, thus being ultimately useful for commercial processing applications into the next generation of feature development and beyond.

The process of the present invention generally comprises 1) providing a densified fluid wherein the fluid is a gas at standard temperature and pressure wherein the density of the fluid is above the critical density of the fluid; 2) providing a cleaning component; 3) intermixing the densified fluid and the cleaning component whereby a reactive cleaning fluid is formed comprising reactive reverse-micelles or reactive aggregates; and 4) contacting a residue on a substrate with the reactive cleaning fluid for a time tᵣ whereby the residue is chemically modified and removed from the substrate. The cleaning component comprises at least one reverse micelle-forming surfactant and/or co-surfactant and/or at least one reactive chemical agent, and combinations thereof. The reactive chemical agent may be added independently of the surfactant/co-surfactant or may be integral to the surfactant itself.

Reaction between the residues of interest and the components in the system (reverse micelles, reactive chemical agents, etc.) chemically modify the residues thereby removing them from the substrate surface. An additional, but optional, step includes rinsing the cleaned surface with a rinsing fluid to aide in the recovery or removal of spent cleaning fluid containing the chemically modified residues.

The term “densified” as used herein refers to fluid forming materials or compounds that exist as gases under standard temperature and pressure (STP) conditions and which (as fluids) are maintained at a density (ρ) above the critical density (e.g., ρ>ρ_{c}) for the specified fluid material. STP is universally defined as a temperature of 0° C. and a pressure of 1 atm [˜1.01 bar]. Densified fluids comprise the group of liquefied gases and/or supercritical fluids. Appropriate temperature and pressure regimes above the critical density may be selected from a plot of reduced pressure (Pᵣ) as a function of reduced density (ρᵣ) whereby the corresponding reduced temperature (Tᵣ) isotherms are specified. The reduced temperature, reduced pressure, and reduced density are further defined by the respective ratios Tᵣ=T/T_{c}, Pᵣ=P/P_{c}, and ρᵣ=ρ/ρ_{c} where T_{c}, P_{c}, and ρ_{c} define the critical temperature, critical pressure, and critical density, respectively. The process of the present invention preferably applies fluids having reduced densities in the range from about 1 to 3. More preferably, fluids are employed having reduced densities in the range from about 1 to 2.

The densified fluid of the present invention preferably comprises CO₂ given the low surface tension (1.2 dynes/cm at 20° C., “Encyclopedie Des Gaz”, Elsevier Scientific Publishing, 1976, pg. 361) and ultimately useful critical conditions (where T_{c}=31° C., P_{c}=72.9 atm (or 1,071 psi), CRC Handbook, 71^{st} ed., 1990, pg. 6-49). For CO₂, the critical density (Pc) is approximately 0.47 g/cc (“Properties of Gases and Liquids”, 3ed., McGraw-Hill, pg. 633) where ρ_{c} is defined by the term (1/V_{c}×Mol. Wt.) where V_{c} is the critical volume. Other gases that may find potential use as densified fluids include, but are not limited to, ethane (C₂H₆), ethylene (C₂H₄), propane (C₃H₈), butane (C₄H₁₀), sulfurhexafluoride (SF₆), and ammonia (NH₃), including substituted derivatives thereof (e.g., chlorotrifluoroethane) and equivalents, although flammability and toxicity issues present safety concerns to be addressed. The flammability limit for butane, for example, is 1.86% by volume in air (CRC Handbook, 71^{st} ed., 1990, pg. 16-16); NH₃ is poisonous.

As noted hereinabove, fluid surface tension also remains a significant concern. As the size of features on semiconductor and wafer surfaces continues to decrease and feature density per unit area continues to increase, surface tension in aqueous and semiaqueous fluids will eventually exceed the feature critical stress σ_{crit}, the point of structure failure, collapsing and/or damaging the features during the drying phase of production to remove water. Surface tension of water at 20° C. is about 73 dynes/cm (CRC Handbook, 71^{st} ed., 1990, pg. 6-8). Dimethyl acetamide, a commercial semiaqueous cleaning fluid, exhibits a surface tension at 30° C. of about 32 dynes/cm (Table of Physical Properties, High Purity Solvent Guide, 2ed., Burdick and Jackson Laboratories, Inc., 1984, pg. 138). In contrast, the surface tension of densified CO₂ at 20° C. is 1.2 dynes/cm (“Encyclopedie Des Gaz”, Elsevier Scientific Publishing, 1976, pg. 338), a factor of from 25 to 60 below the surface tension for a comparable semi-aqueous or aqueous fluid, respectively. And, while surface tension for water is negligible in the supercritical phase, dissolution of the wafer substrate becomes significant at the elevated critical temperature for water (T_{c}=371.4° C., CRC Handbook 71^{st} ed., 1990, pg. 6-49). Thus, semi-aqueous and aqueous fluids continue to be problematic cleaning fluids at best. Densified fluids, including densified and liquefied CO₂ gas and supercritical CO₂ fluid can thus be used to address the fundamental surface tension concern associated with aqueous and semi-aqueous cleaning solutions given that surface tension becomes negligible as the fluid approaches the critical point.

The person of ordinary skill in the art will recognize the wide selection of temperature and pressure profiles usable in conjunction with the systems of the present invention. For example, pressures up to 10,000 psi and temperatures fully encompassing the range of densified and super critical fluids may be envisioned. Thus, no limitation is intended by the disclosure of conditions herein ideally suited substrate processing operations.

The temperature of densified CO₂ gas (e.g., liquefied CO₂) is preferably in the range from about −80° C. to 150° C. with a pressure up to about 3000 psi inclusive. More preferably, a temperature may be selected of up to and including 60° C. with a pressure in the range from 850 psi up to 3000 psi inclusive. Most preferably, conditions are selected whereby temperature is at or near room temperature (approximately 20-25° C.), pressure is approximately 850 psi, and density in the densified liquid exceeds the critical density of pure CO₂ (e.g., ρ_{c}>0.47 g/cc).

Density increases may also be exploited in a densified fluid by effecting changes to pressure and/or temperature in the system. For example, density in a pure liquefied CO₂ fluid at 20° C. and approximately 870 psi (60 bar) is 0.78 g/cc [“Encyclopedie Des Gaz”, Elsevier Scientific Publishing, 1976, pg. 338]. At 2900 psi (200 bar), density increases the fluid to approximately 0.94 g/cc, a 20% increase. Similar or greater effects can be attained in supercritical (SC) fluids whereby higher densities can be exploited as a function of pressure and/or temperature. For example, in a pure supercritical CO₂ fluid at 40° C. and 1300 psi, density is approximately 0.48 g/cc. At 2900 psi, density in the SC fluid increases to 0.84 g/cc, a 75% increase. In general, for a CO₂ fluid system under supercritical fluid (SCF) conditions, the system need only exceed the critical parameters where T_{c}=31° C.; P_{c}=1,071 psi; and ρ_{c}=0.47 g/cc. Thus, above a temperature of about 32° C., a pressure for an SCF system need only be selected whereby the density exceeds the critical density of CO₂. Temperatures for SCF systems up to 150° C. are conceptually practicable if the density of the solution mixture is maintained above the critical density. Because the polarity of a densified or supercritical fluid is too low to effect removal of tenacious residues of interest from a substrate surface, additional modifications to the fluid must be made, as described hereinafter.

Surfactants of the present invention are preferably selected from the group of reverse-micelle forming surfactants and co-surfactants including, but not limited to, CO₂-philic, anionic, cationic, non-ionic, zwitterionic, and combinations thereof. Presently, surfactants preferably comprise a perfluoro-poly-ether (PFPE) backbone or equivalent fluorocarbon-containing tail so as to be soluble in the densified fluid medium. Anionic reverse micelle forming surfactants include, but are not limited to, various classes of fluorinated hydrocarbons, and fluorinated and non-fluorinated surfactants, including PFPE surfactants, PFPE carboxylates (including PFPE ammonium carboxylates), PFPE phosphate acids, PFPE phosphates, fluorocarbon carboxylates, PFPE fluorocarbon carboxylates, PFPE sulfonates (including PFPE ammonium sulfonates), fluorocarbon sulfonates, fluorocarbon phosphates, alkyl sulfonates, sodium bis-(2-ethyl-hexyl) sulfosuccinates, ammonium bis-(2-ethyl-hexyl) sulfosuccinates, and combinations thereof. Cationic reverse micelle forming surfactants include but are not limited to the tetra-octyl-ammonium fluoride class of compounds. Non-ionic reverse micelle forming surfactants include, but are not limited to, the poly-ethylene-oxide-dodecyl-ether class of compounds, their substituted derivatives, and functional equivalents thereof. Zwitterionic reverse micelle forming surfactants include, but are not limited to, the alpha-phosphatidyl-choline class of compounds, their substituted derivatives, and functional equivalents thereof. Co-surfactants include, but are not limited to, the group of alkyl acid phosphates, alkyl acid sulfonates, alcohols of general formula ROH where R is any alkyl or substituted alkyl group (e.g., alkyl alcohols, perfluoroalkyl alcohols), dialkyl sulfosuccinate surfactants, derivatives, salts, and functional equivalents thereof. Co-surfactants are preferably selected from the group consisting of sodium bis-(2-ethyl-hexyl) sulfosuccinates (e.g., sodium AOT), ammonium bis-(2-ethyl-hexyl) sulfosuccinates (e.g., ammonium AOT), and their functional equivalents or the like. Surfactants and/or co-surfactants not miscible in the bulk densified fluid or solvent (e.g., non-CO₂-philic) may also be rendered soluble and/or capable of forming reverse micelles and thus be suitable for use in the densified fluid provided at least one miscible (e.g., CO₂-philic) reverse-micelle-forming surfactant or co-surfactant is used in the surfactant combination. As such, the person of ordinary skill in the art will recognize that the useful scope of surfactant and co-surfactant classes is wide whereby many effective embodiments of reverse micelle forming surfactants and co-surfactants can be used in conjunction with the present invention. Thus, no limitation in scope is intended by the disclosure of the preferred embodiments.

Reactive chemical agents of the present invention comprise the group of reagents or modifiers that when added to the densified fluid provide chemical reactivity to the reactive cleaning fluid. The term “reactive” as used herein describes and defines or otherwise refers to the ability of modifiers or chemical agents in the bulk densified fluid and/or reverse micelle(s)/aggregates to chemically modify or react with tenacious residues such that residues are removed from the substrate surface. Agents providing reactivity may be the surfactant/co-surfactant itself and/or components thereof, and/or may be separate chemical modifiers added to the bulk fluid and/or the reverse micelle(s)/aggregate(s). Reactive chemical agents or modifiers are preferably selected from the group of mineral acids, fluoride-containing compounds and acids, organic acids, amines, alkanolamines, hydroxylamine, peroxides and other oxygen-containing compounds, chelates, ammonia, and combinations thereof. Mineral acids are preferably selected from the group of hydrochloric (HCl), sulfuric (H₂SO₄), phosphoric (H₃PO₄), and nitric (HNO₃), their respective acid dissociation products (e.g., H⁺, HSO₄⁻¹, H₂PO₄⁻¹, HPO₄⁻², etc.) and salts, and combinations thereof. Preferred fluoride-containing compounds and acids include, but are not limited to, F₂, hydrofluoric acid (HF), various dilution acids thereof up to and including ultra-dilute hydrofluoric acid (UdHF: 1:1000 dilution of 49 vol % HF in water). Organic acids include the sulfonic acids (R—SO₃H) and corresponding salts, phosphate acids (R—O—PO₃H₂) and corresponding salts, and phosphate esters and salts, substituted derivatives, and functional equivalents thereof. Preferred alkanolamines and other amines include, but are not limited to, ethanolamine (HOCH₂CH₂NH₂) and hydroxylamine (HO—NH₂), derivatives, and functional equivalents thereof. Peroxides include, but are not limited to, organic peroxides (R—O—O—R′), alkyl peroxides (R—C—O—O—R′), t-butyl peroxide [(H₃C)₃C—O—O—R′), hydrogen peroxide (H₂O₂), substituted derivatives, and combinations thereof. Oxygen containing compounds include, but are not limited to, oxygen (O₂) and ozone (O₃), and functional or reactive equivalents. Chelates include, but are not limited to, pentandiones; 1,1,1,5,5,5-hexa-fluoro-2,4-pentandione (also known as hexa-fluoro-acetyl-acetonate or 2,4 pentanedione), phenanthrolines; 1,10-phenanthroline (C₁₂H₈N₂), oxalic acid [(COOH)₂], and aminopolycarboxylic acids including ethylene-di-amine-tetra-acetic-acid (EDTA), derivatives, and salts (e.g., sodium EDTA, etc.) thereof.

Corrosion inhibitors may be added as constituents or modifiers to the reactive cleaning fluids and systems of the present invention to passivate and inhibit loss of base metal layers comprising copper or other metals. Inhibitors include, but are not limited to, benzotriazoles including 1,2,3-Benzotriazole, and catechols including catechol, 1,2-Di-hydroxy-benzene (pyrocatechol) and 2-(3,4-Di-hydroxy-phenyl)-3,4-di-hydro-2H-1-benzopyran-3,5,7-triol (catechin), substituted derivatives, and equivalents thereof.

Intermixing of the densified fluid, the at least one reverse micelle-forming surfactant and/or co-surfactant, and/or the reactive chemical agent generates the reactive cleaning fluid. In one of many possible fluid configurations, intermixing of the components in the fluid forms “reactive” reverse micelle(s) or “reactive” aggregates wherein reactive chemical constituents reside within the polar micellar cores. Alternatively, reactive chemical modifiers may reside in the bulk densified fluid or be distributed both in the bulk fluid and the micellar core. Size of the reverse micelles is defined by the molar water-to-surfactant ratio, e.g., [H₂O]/[Surfactant]. The functional “reactive” reverse micelles or aggregates have diameters (tail to tail) preferably in the range from about 50 Å to 5000 Å inclusive. The person of ordinary skill in the art will recognize that sizing and/or dimensions of the reactive reverse micelle(s) can vary depending on molecular weight or size of the surfactants employed, as well as other chemical constituents or modifiers employed in the system. Thus, no limitation in scope is hereby intended by disclosure of the preferred system embodiments.

The multi-component fluid mixture is subsequently raised to selected temperatures and pressures whereby the density (ρ) in the fluid exceeds the critical density (ρ_{c}) of the bulk fluid thereby effecting formation of a densified reactive cleaning fluid. The effectiveness of the fluid system toward residues is determined by the reaction between, and reactivity of, the reactive reverse micelle(s) and/or reactive aggregates and the targeted substrate residues of interest. Optimum removal of residues is achieved by effecting a direct chemical reaction between the residues of interest and the reactive reverse micelle(s) or reactive aggregate(s) in the densified fluid.

Rinsing fluids may be employed optionally to assist in the recovery or removal of the spent reactive cleaning fluid containing chemically modified residues. Rinsing fluids preferably comprise the pure densified fluid (e.g., CO₂ in a densified liquid or supercritical state) or, alternatively, a fluid containing other CO₂-miscible organic solvents, polar fluids, and/or co-solvents having concentrations up to about 30% by volume in the bulk densified fluid including, but not limited to, alcohols of general formula ROH where R is any alkyl or substituted alkyl group having a carbon number in the range from 1 to 12, iso-propyl-alcohol [iPrOH], methanol [MeOH], and ethanol [EtOH] being representative but not exclusive compounds; carboxylic acids of general formula R-COOH where R is any alkyl or substituted alkyl group having a carbon number in the range from 1 to 11 (e.g., formic acid [HCOOH], etc.); tetrahydrofurans (THF), chlorinated and/or fluorinated hydrocarbons including, but not limited, to chloroform, and methylene chloride; and other polar liquids including, but not limited to, water. Examples include a rinsing fluid comprising 5% iPrOH in the bulk densified CO₂ fluid or alternatively, a densified CO₂ fluid saturated with H₂O. Other soluble and/or miscible polar compounds in liquefied CO₂ as reported by Francis in (J. Phys. Chem., 58, 1099-1114, 1954) are hereby incorporated.

Effectiveness of a reactive cleaning system for wafer or semiconductor processing is also a function of 1) maintaining a sufficiently low surface tension to minimize damage to the critical or intricate surface structures; 2) retaining dimensional and/or site attributes of the patterned features or structures of a substrate or wafer surface during processing; 3) retaining a sufficient polarity in the cleaning fluid for solubility among and between the various chemical moieties, modifiers, and constituents; and 4) maintaining reactivity between and among the chemically reactive modifiers and/or constituents in the densified fluid medium so as to effect residue removal.

Residue analysis results using Scanning Electron Microscopy (SEM) examination and X-Ray Photoelectron Spectroscopy (XPS) show systems of the present invention are distinguished at a minimum from other densified fluid systems known in the art in both in their reactivity and ability to effect removal of tenacious residues that continue to prove problematic to the semiconductor industry, including transition metal residues (e.g., Cu and Fe), other metal residues (e.g., Al), as well as non-metal and/or etch residues (e.g., containing C, N, F, Si, P, etc.). Further, results show a contact time tr with or in the reactive fluids on the order of 5 minutes or less can effect removal of residues, a significant advancement in the art. In sum, the systems of the instant invention present a new capability for attacking and removing unwanted and tenacious residues from a semiconductor or wafer substrate surface.

It is an object of the present invention to show a reactive reverse-micelle cleaning system that 1) optimizes wafer cleaning performance by removing etch residues and other metal and non-metal residues; 2) comprises low quantities of chemical modifiers; and 3) exhibits low overall toxicity. The term “modifiers” defines any additive (chemical or otherwise) introduced to the fluids of the present systems to enhance reactivity, cleaning performance, speed, and/or efficiency for removing tenacious residues. Preference is given to modifiers, additives, solvents, and fluids that in the various application aspects are easily recovered and that lower commercial processing costs. Optimization benchmarks include achieving 1) essentially complete removal of residues; 2) greater efficiency and/or speed of residue cleaning than is currently known in the art; 3) cleaning levels for residues that remain efficacious for commercial wafer and/or semiconductor processing; and 4) a reduction in the number of critical dimension (CD) changes to substrate features and patterns (e.g., vias) or other important substrate structures. The term “critical dimension” changes refers to alterations in the size or dimensions (e.g., pitch) of patterns or structural features such as vias on the wafer substrate or surface. Preference is given to systems that minimize changes to functional components of the wafer surface or substrate.

### BRIEF DESCRIPTION OF THE DRAWINGS

A more complete appreciation of the invention will be readily obtained by reference to the following description of the accompanying drawings in which like numerals in different figures represent the same structures or elements. The invention may be embodied in many forms and should not be construed as being limited to the embodiments set forth herein.

FIG. 1 illustrates a generalized reaction scheme for a reactive reverse micelle residue cleaning system according to the present invention.

FIG. 2 illustrates four representative reactions involving reactive constituents and residues in the cleaning system according to the process of the present invention.

FIG. 2A illustrates a first representative reaction between reactive constituents and residues in the cleaning system to remove chemically modified residues.

FIG. 2B illustrates a second representative reaction between reactive constituents and residues in the cleaning system to remove chemically modified residues.

FIG. 2C illustrates a third representative reaction between reactive constituents and residues in the cleaning system to remove chemically modified residues.

FIG. 2D illustrates a fourth representative reaction between reactive constituents and residues in the cleaning system to remove chemically modified residues.

FIG. 3 shows an SEM micrograph of an as received OSG no barrier open (NBO) wafer substrate containing over-etch processing residues including crumbs, striations, and mounds.

FIG. 4 shows exploded cross-sectional views of a mixing chamber and a cleaning vessel according to the present invention.

FIG. 5 illustrates a complete wafer cleaning system design showing the combination of mixing vessel, wafer cleaning vessel, syringe pump, valves, and associated transfer lines.

FIG. 6 illustrates a reactive reverse micelle system for removing semiconductor residues according to a first embodiment of the present invention comprising PFPE phosphate, alkyl sulfonate (e.g., AOT), and water.

FIG. 7 presents an SEM micrograph of a cleaned OSG no barrier open (NBO) test wafer showing effective removal of surface residues using a reactive reverse micelle system according to a first embodiment of the present invention.

FIG. 8 illustrates a reactive reverse micelle system comprising PFPE ammonium carboxylate and hydroxylamine for removing semiconductor residues according to a second embodiment of the present invention.

FIG. 9 shows an SEM micrograph of a cleaned OSG no barrier open (NBO) test wafer showing the effective removal of surface residues using a reactive reverse micelle system according to a second embodiment of the present invention.

### DETAILED DESCRIPTION OF THE INVENTION

While present invention is described herein with reference to the preferred embodiments thereof, it should be understood that the invention is not limited thereto, and various alternatives in form and detail may be made therein without departing from the spirit and scope of the invention. In particular, those of ordinary skill in the art will appreciate that combining and intermixing the various fluids and reactive components as currently practiced and described herein may be effected in numerous and effectively equivalent ways. For example, application of the method steps on a commercial scale may comprise use of high-pressure pumps and pumping systems, and/or transfer systems for moving, transporting, transferring, combining, intermixing, as well as delivering and applying the various cleaning fluids. Associated application and/or processing techniques for utilizing the reactive cleaning fluids of the present invention for ultimately cleaning substrate surfaces, or for post-processing collection of waste solutions and chemical constituents are also envisioned and encompassed hereby, as would be performed by those of ordinary skill in the art.

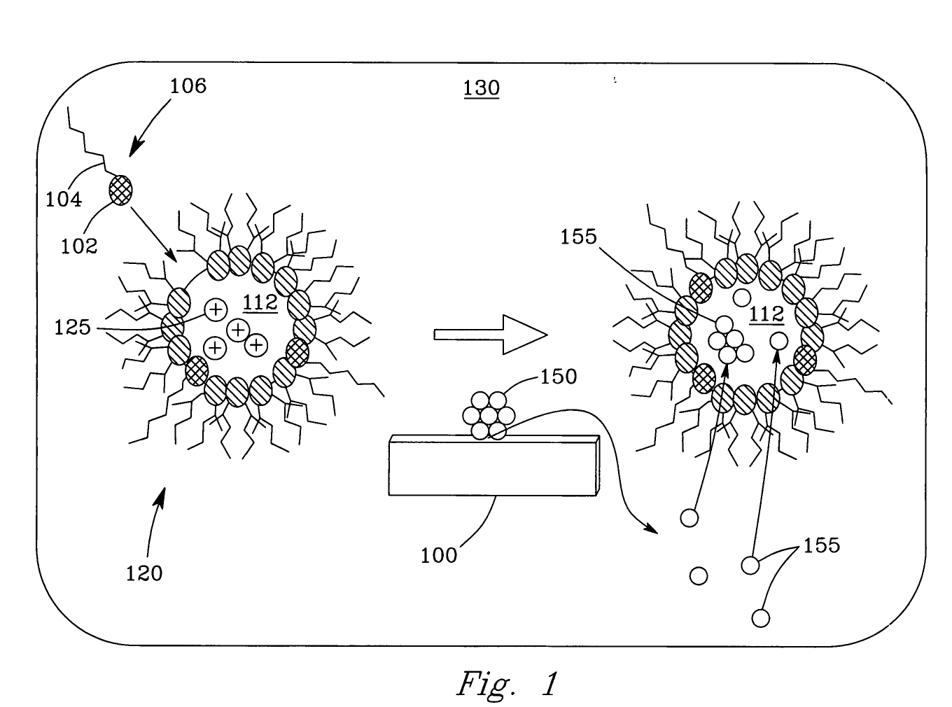

FIG. 1 shows a generalized reaction and process scheme for a reactive reverse micelle fluid system according to the process of the present invention. CO₂-philic surfactants 106 comprising a polar head group 102 and a CO₂-philic tail 104 combine to form aggregates 120 or reverse micelles 120 in the densified fluid 130. The polar heads 102 align in close proximity in the aggregate 120 or reactive reverse micelles 120, forming a polar inner core 112. Reactive chemical agents 125 in the polar core 112 and/or the bulk densified fluid 130 provide reactivity toward residues 150 in combination with the reactive reverse micelles 120 thus constituting a “reactive” reverse micelle fluid system. More specifically, residues 150 on the surface of the wafer 100 react with the reactive constituents 125 in the fluid system thereby becoming chemically modified residues 155 that are removed or separated from the surface of the substrate 100 and which then subsequently reside within the polar core 112 or the densified fluid 130. Reactions by which residues 150 become chemically modified residues 155 which can be removed from the surface of the substrate 100 include, but are not limited to, chemical reactions, oxidation, reduction, exchange, molecular-weight reduction, fragment cracking, dissociation, complexation, head-group or inner micelle core binding, and combinations thereof.

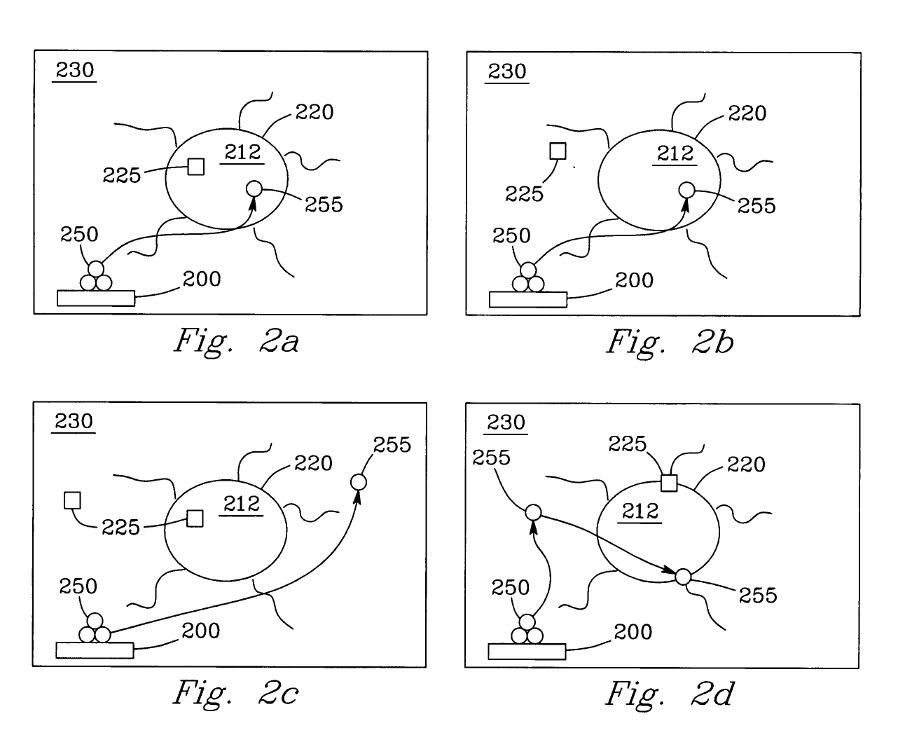

Referring now generally to FIG. 2, four representative reaction types involving reactive constituents 225, reverse micelles 220, and residues 250 in the densified fluid 230 are illustrated whereby the chemically modified residues 255 are removed from a substrate 200 surface. The person of ordinary skill in the art will recognize the illustrated reactions to be representative of the general types of reactions that may be involved. Thus, no limitation is intended by the disclosure thereof.

FIG. 2A illustrates a first reaction type in which a chemical agent 225 present in the polar micelle core 212 of the reverse micelle 220 reacts with a residue 250 on the surface of a substrate 200 yielding a chemically modified residue 255 that is removed from the substrate 200 and which resides within the polar micelle core 212, e.g., a reaction whereby a polar and/or water-soluble residue is formed.

FIG. 2B illustrates a second reaction type in which a reactive chemical agent 225 present in the densified fluid 230 reacts with a residue 250 on the surface of a substrate 200 yielding a chemically modified residue 255 that is removed from the surface of a substrate 200 and which resides within the polar micellar core 212. For example, a reaction between a residue and a chemical agent 225 in the densified fluid 230 whereby a polar and/or water-soluble chemically modified residue 255 is formed.

FIG. 2C illustrates a third reaction type in which a reactive chemical agent 225 in the polar core 212 of the reactive reverse micelle 220 reacts with a residue 250 on the surface of a substrate 200 whereby the resultant chemically modified residue 255 is removed from a surface and resides in the bulk densified fluid 230 separate from the substrate 200 surface. For example, a reaction between an acid (e.g., HF) 225 present in the micellar core 212 with a residue 250 whereby a non-polar and/or neutral moiety (e.g., SiF₄) 255 miscible in the densified fluid 230 is generated. Alternatively, a reaction between a metal residue 250 (e.g., Cu) on the substrate 200 surface, a chemical agent [i.e., peroxide (H₂O₂)] 225 in the micellar core 212, and a chemical agent 225 [i.e., 2,4-pentandione, a complexing agent] in the densified fluid 230 yielding a chemically modified residue 255 as a CO₂-philic moiety, i.e., copper-hexa-fluoro-acetyl-acetonate.

FIG. 2D illustrates a fourth reaction type in which a chemical agent 225 present as a constituent or component of the reverse micelle 220 (e.g., a head group) reacts with a residue 250 on the surface of a substrate 200 yielding chemically modified residues 255 ultimately retained in the micellar core 212. For example, a metal-surfactant complex 255 formed between a chemically modified metal residue (e.g., Cu⁺) 255 and the anion (e.g., PO₄²⁻) of a phosphate surfactant head group (e.g., PFPE-PO₄²⁻) 225 retained in the reverse micelle core 212. Alternatively, a reaction with a quaternary ammonium fluoride surfactant, i.e., tetra-octyl-ammonium-fluoride.

The person of ordinary skill in the art will recognize that many reactants, potential reactive mechanisms, and reaction products are possible depending on the types of residues 250 on the surface of a substrate 200, chemical reagents 225, composition of the reactive reverse micelles 220 or aggregates 220 utilized, and the chemically modified residues 255 generated. In general, numerous and varied reactive outcomes that result in removal of residues 250 from a surface may be effected by the combined action of the reactive reverse micelles 220 or aggregates 220, the reactive chemical agents 225 present in the cleaning system and the reactivity and selectivity toward substrate residues 250. As shown hereinabove, chemically modified residues 255 may become miscible in the bulk densified fluid 230 or within the polar core 212 of the reactive micellar aggregates 220 either as freely mobile and soluble species or alternatively as bound or complexed species with the components or constituents comprising the aggregate 220 whereby the chemically modified residues 255 are ultimately removed from the substrate 200 surface. Other reactive combinations as would be envisioned by the person of ordinary skill in the art are hereby incorporated.

It should be emphasized that the presence of an inner polar core 212 in a micellar system is, by itself, insufficient to chemically modify or remove high molecular weight residues 250 from the surface of a substrate 200 or the resultant modified residues 255, as evidenced by the number of simple densified systems known in the art that remain presently ineffective at removing tenacious residues because they constitute non-reactive systems. It has been shown, for example, that the reactive components 225 in the bulk fluid 230 or reverse micelle core 212 must be brought into direct and reactive contact with the substrate residue 250 for a sufficient contact time tᵣ for the necessary chemical reactions to occur. Reactive agents 225 in the polar core 212 of a reactive reverse micelle 220 or reactive aggregates 220 must interact reactively and directly with surface residues 250 for chemical modification to occur. Only then can the modified residues 255 be removed from the substrate surface as miscible moieties in the densified fluid 230 or as chemically modified species 255 within the polar core 212 of the reactive reverse micelles 220 pending recovery of the components in the densified fluid 230.

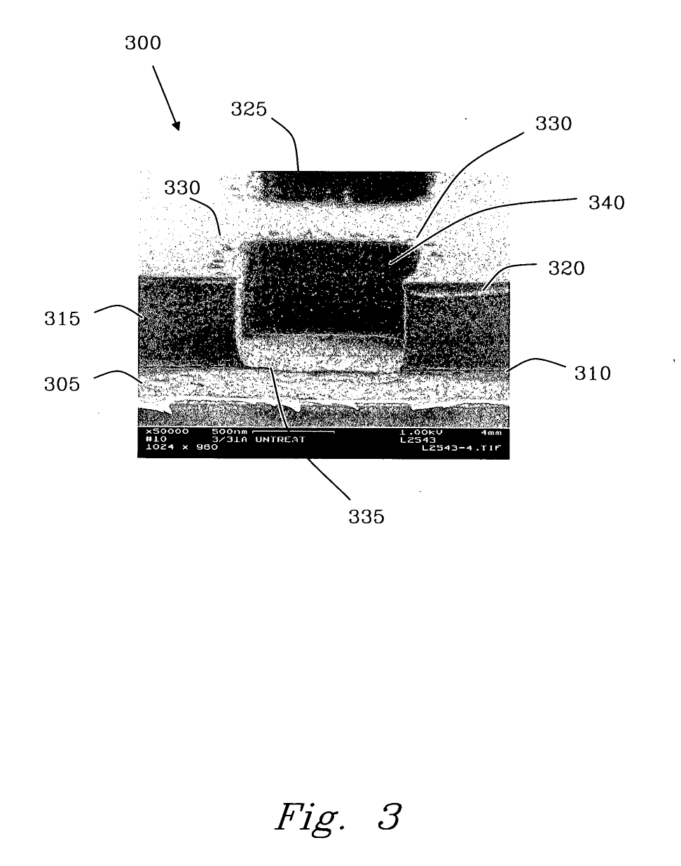

FIG. 3 shows an over-etched wafer coupon 300 comprising a base layer 305 of a representative metal, e.g., a transition metal such as copper (Cu) or another metal such as aluminum (Al). In the instant case, the base layer 305 comprising copper was overlaid with an etch stop (e.g., barrier) layer 310 comprising silicon carbide (SiC) followed by a dielectric material layer 315 comprising organo-silane glass (OSG), a standard interlayer low-K dielectric material known in the art, or another porous low-K dielectric material (LKD), and a coating or insulating overlayer 320 comprising silicon dioxide (SiO₂) or other thin film. In each test wafer 300, small pattern wells 325 called “vias” 325 were introduced into the OSG 315 (or LKD) layer through the SiO₂ coating layer 320. The as received test coupons 300 were generally of a “no barrier open” (NBO) or “barrier open” (BO) configuration purposely “over-etched” to enhance the quantity of surface residues for testing. NBO substrates are representative of wafers encountering a first etching (plasma or chemical) step in a commercial process whereby pattern vias 325 and/or other micro and macro structures are etched into the dielectric material layer 315 (e.g., LKD or OSG) but do not breach the etch stop (barrier) layer 310. In FIG. 3, the over-etched wafer 300 surface is shown comprising residues from plasma etch processing in the form of crumb 330 deposits, mounds 335, and striations 340 deposited on the walls or in the (1 μm) pattern vias 325. Further processing that breaches the stop layer (e.g., SiC) constitutes a “barrier open” substrate. The wafer coupons 300 were sized as necessary for testing by scoring and breaking the wafers along the crystal planes.

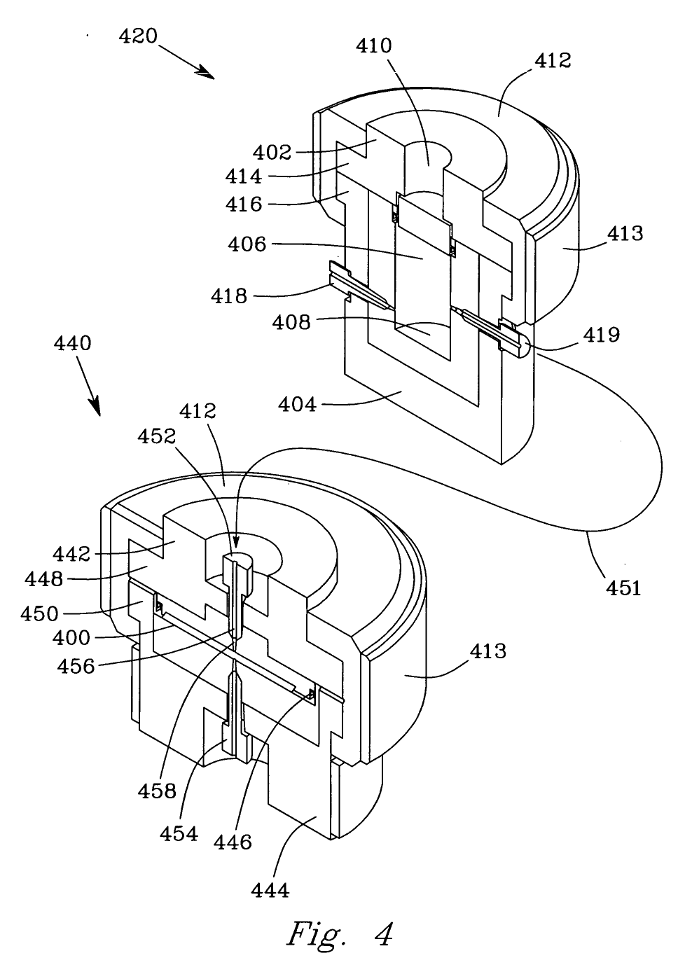

FIG. 4 illustrates simplified wafer cleaning equipment of a benchtop scale design for practicing the process of the present invention. The person or ordinary skill in the art will recognize that equipment is application driven and can therefore be scaled and/or configured as necessary to meet the specific application and/or industrial requirements without deviating from the spirit and scope of the invention, e.g., scaled to accommodate a 300 mm diameter wafer, etc. Thus, no limitation is hereby intended by the disclosure of the instant equipment design applicable to a small test wafer coupon.

FIG. 4 shows both a mixing vessel 420 and a wafer cleaning vessel 440 in cross section. The mixing vessel 420 is comprised of a top vessel section 402 and a bottom vessel section 404 machined preferably of titanium (Ti) metal. The vessel 420 may be lined with any of a number of high strength polymer liner(s) 406 to minimize potential of contaminating metals (including but not limited to Cu, Fe, and Ti) and particulates being introduced into the mixing vessel 420. The liner 406 is preferably made of poly-ether-ether-ketone, also known as PEEK™, available commercially (Victrex USA, Inc., Greenville S.C. 29615) or an alternative such as poly-tetra-fluoro-ethylene (PTFE), also known as Teflon™, available commercially (Dupont, Wilmington, Del. 19898). When assembled, the top vessel section 402 and bottom vessel section 404 define a mixing chamber 408 with an internal diameter of 1.14 inches and a length of 1.75 inches, and an internal volume of approximately 30 mL. Contents of the vessel 420 are stirred with a magnetically coupled Teflon™ stir bar via a standard temperature controlled heating plate. A sapphire observation window 410 available commercially (Crystal Systems, Inc., Salem, Mass. 01970) is inserted into the top vessel section 402 for observing fluids introduced into the vessel 420 and for inspecting the phase behavior in the mixing solutions. The window 410 has dimensions of about 1-inch in diameter and 0.5 inches in thickness. The vessel sections 402 and 404 and window 410 are assembled and secured in place with a clamp 412 that slidably mounts to close over securing rim edge portions 414 and 416 machined into each of the top 402 and bottom 404 vessel sections, respectively, thereby effecting a pressure seal within the mixing vessel 420. The clamp 412 is secured in place via a locking ring 413 positioned and aligned about the perimeter of the clamp 412.

The mixing vessel 420 is further configured with a port 418 to the mixing chamber 408 used as an inlet port 418 and a port 419 from the mixing chamber 408 used as an exit port 419. Fluid flow into the mixing chamber 408 is reversible as ports 418 and 419 may be used interchangeably as exit or inlet ports depending on desired flow direction. Both ports 418 and 419 have dimensions preferably in the range from 0.020 inches I.D. to 0.030 inches I.D.

The wafer cleaning vessel 440 is comprised of a top vessel section 442 and a bottom vessel section 444 machined preferably of titanium (Ti) metal and lined with a high strength polymer liner 406 to minimize potential of contaminating metals being introduced into the cleaning vessel 440. When assembled, the top 442 and bottom 444 sections define a wafer cleaning chamber 446. Sections 442 and 444 are assembled and secured in place with a clamp 412 that slidably mounts to close over securing rim portions 448 and 450 machined into each of the top 442 and bottom 444 vessel sections, respectively, thereby effecting a pressure seal within the cleaning vessel 440. The clamp 412 is secured in place via a locking ring 413 positioned and aligned about the perimeter of the clamp 412.

The cleaning vessel 440 is further configured with an inlet port 452 into the cleaning chamber 446 and an outlet port 454 from the cleaning chamber 440, each port having dimensions preferably in the range from 0.020 inches I.D. to 0.030 inches I.D. The wafer vessel 440 has an internal diameter of 2.5 inches and a height of 0.050 inches defining a total internal volume of approximately 500 μL. Cleaning fluids are introduced via transfer line 451 from the mixing vessel 420 to the cleaning vessel 440 and into the cleaning chamber 446 through a small inlet hole 456 introduced in the top vessel section 442 through the PEEK™ liner 406. The top vessel section 442 includes a 0.020 inch vertical channel head space 458 above the wafer surface 400 whereby fluids introduced into the chamber 446 producing a radial flow field that spreads tangentially outward across the wafer 400 surface.

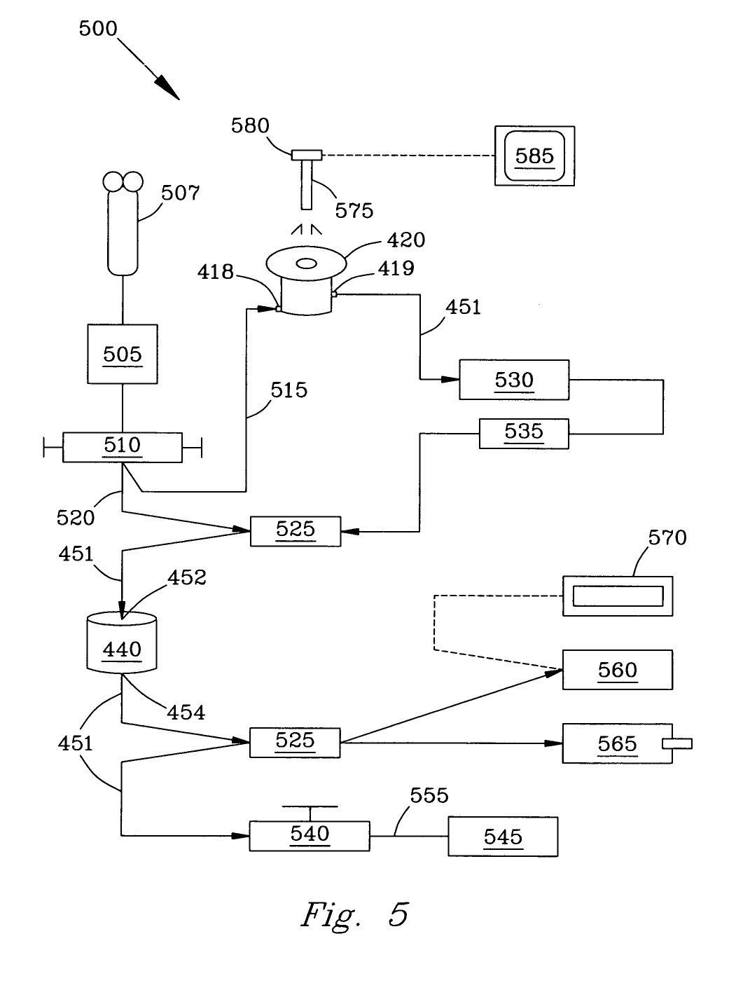

FIG. 5 illustrates a complete cleaning system 500 of a benchtop scale design according to the apparatus of the present invention. The mixing vessel 420 is shown in fluid connection with the cleaning vessel 440 via a series of high-pressure liquid chromatography (HPLC) transfer lines 451. Transfer lines 451 are preferably 0.020 inch I.D. by 1/16-inch O.D. HPLC lines made of PEEK™ available commercially (Upchurch Scientific, Inc., Whidbey Island, Wash.). Pressure is maintained in the system using a feed pump 505 (for example, a 500 mL model #500-D microprocessor-controlled syringe pump 505 available commercially [ISCO, Inc., Lincoln, NB]) in fluid connection with a tank 507 of ultra-high-purity CO₂.

A valve 510 (for example, a model 15-15AF1 three-way/two-system combination valve 510 available commercially [High Pressure Equipment Co., Erie, Pa. 16505]) is inserted in the transfer line 451 leading from the pump 505 forming two independent fluid flow paths 515 and 520. The first flow path 515 defines a cleaning loop 515 extending from the valve 510 to the inlet port 418 and into the mixing vessel 420. The second flow path 520 defines a rinsing loop 520 extending from the valve 510 to the inlet port 452 and into the wafer cleaning vessel 440. A T-fitting 525 (for example, a model P-727 PEEK™ Tee [Upchurch Scientific, Inc., Whidbey Island, Wash.]) is inserted in the transfer line 451 of the cleaning loop 515 between the exit port 419 of the mixing vessel 420 and inlet port 452 of the cleaning vessel 440. The fitting 525 further connects with the transfer line 451 of the rinsing loop 520 bringing the cleaning loop 515 and the rinsing loop 520 into fluid connection whereby cleaning fluid from the mixing vessel 420 or rinsing fluid from the syringe pump 505 may be introduced to the wafer cleaning vessel 440.

Further incorporated into the transfer line 451 of the cleaning loop 515 between the exit port 419 and the fitting 525 are two inline filters, a 2 μm pre-filter 530 (for example, a model A-410 HPLC Filter Assembly [Upchurch Scientific, Inc., Whidbey Island, Wash.]) and a 0.5 μm post filter 535 (for example, a model A-431 HPLC Filter Assembly [Upchurch Scientific, Inc., Whidbey Island, Wash.]) that prevent potential contaminant metals and/or particulates present in the cleaning fluids from being introduced into the wafer cleaning vessel 440.

A straight valve 540 (for example, a model 15-11AF1 two-way straight valve [High Pressure Equipment Co., Erie, Pa. 16505]) connects via standard 0.020-0.030 inch I.D. PEEK™ transfer line 451 to a second T-fitting 525 and to a waste collection vessel 545 via a “restrictor” segment 555 of PEEK™ transfer line 451 having internal dimensions of approximately 0.005 inch I.D. and a length of from 8 to 12 inches. The T-fitting 525 is further connected via transfer line 451 to the exit port 454 of the cleaning chamber 440 and to a pressure transducer 560 in electrical connection with a pressure readout or display device 570 (for example, a model C451-10,000 combination pressure transducer and pressure display [Precise Sensors, Inc., Monrovia, Calif. 91016-3315]) for monitoring and reading pressure in the system 500, and to a rupture disc 565 (for example, a model 15-61AF1 safety head [High Pressure Equipment Co., Erie, Pa. 16505]) used as a pressure safety vent.

As shown in FIG. 5, the mixing chamber 420 is further illuminated with an optional light source 575 (for example, a model 190 fiber optic illuminator 570 [Dolan-Jenner, St. Lawrence, Mass. 01843-1060]). The light source 570 preferably comprises a one foot long positional gooseneck fiber optic and a focusing lens equipped with a 30-watt bulb for focusing and directing light through the observation window 410 into the mixing chamber 408. An optional high performance camera 580 (for example, a Toshiba model IK-M41F2/M41R2 CCD camera available commercially [Imaging Products Group, Florence, S.C. 29501]) is also preferably coupled to or used in conjunction with the illuminator 575 and a standard video display 585 to image the mixing chamber 408 and contents.

Intermixing of the components and/or constituents to form the reactive cleaning fluid is done for about 5 to 10 minutes in the mixing vessel 420 by charging the vessel 420 with pure densified fluid 130 prior to transfer to the cleaning vessel 440. Pressure is programmed into and maintained by the microprocessor-controlled syringe pump 505. Metering of fluids from the mixing vessel 420 into the cleaning vessel 440 is initiated by opening the straight valve 540 thereby initiating flow through the restrictor segment 555. Fluids are discharged at a rate of about 30 mL/min. Each transfer of fluid from the mixing vessel 420 involves about 7 mL of pre-mixed cleaning fluid. Closing of the valve 540 traps cleaning fluid in the cleaning vessel 440 whereby a residence or contact time tᵣ with the wafer effects cleaning. Rinsing fluids comprising the pure densified solvent for rinsing of the wafer are preferably introduced to the cleaning vessel 440 via the rinsing loop 520. Rinsing fluids requiring intermixing with other fluids or solvents may be introduced through the mixing vessel 420 to the cleaning vessel 440 via the cleaning loop 515. Post-processing examination of the test surfaces was conducted using conventional SEM and/or XPS analysis.

The following examples are intended to promote a further understanding of the reactive systems of the present invention. Examples 1-4 present four different embodiments of a reactive reverse micelle cleaning system according to the process of the present invention.

### EXAMPLE 1

### Reverse Micelle System Comprising Perfluoropolyether Phosphate Surfactant/Alkyl Sulfonate Co-Surfactant/Water

### Residue Cleaning System

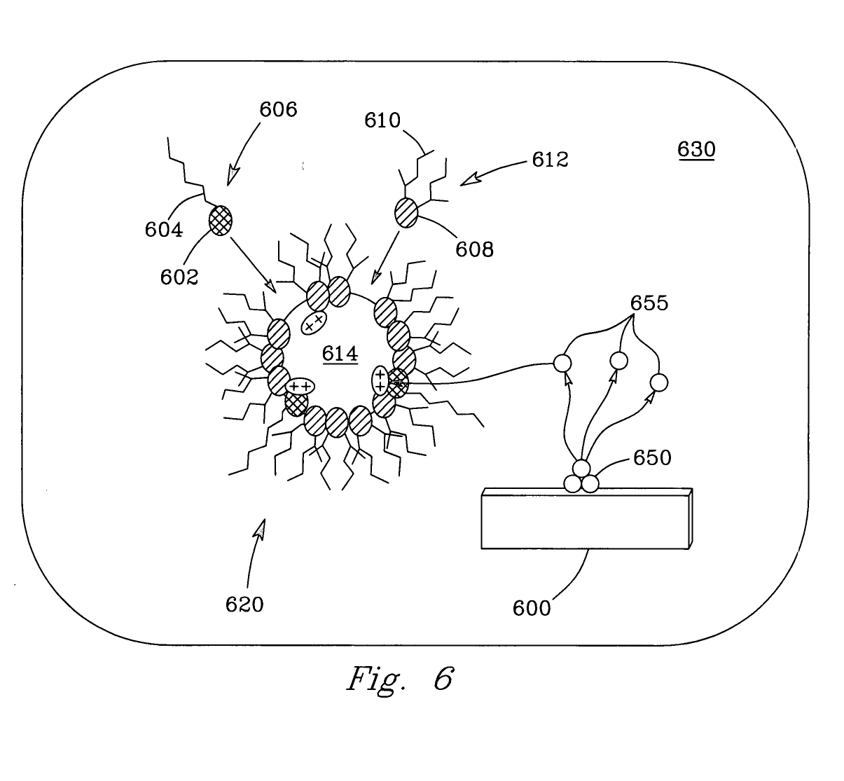

FIG. 6 illustrates a reactive reverse micelle(s) system according to a first embodiment of the present invention. Illustrated is a perfluoro-poly-ether (PFPE) phosphate surfactant/alkyl-sulfonate (AOT) co-surfactant/water system for removing etch residues 650 and non-metal residues 650 found to be tenacious and problematic residues for semiconductor and/or wafer substrate surface processing. This system has very attractive attributes for commercial processing including very low quantities of modifiers, very low volatility, ease of fluid recovery, low toxicity, minimal CD changes, and high speed cleaning. Cleaning occurs preferably in a time below about 15 minutes per wafer on average, and more preferably in less than about 5 minutes.

The system of the present embodiment comprises reactive reverse micelles 620 or reactive aggregates 620 comprising a PFPE phosphate surfactant 606 and a dialkyl sulfosuccinate (AOT) co-surfactant 612 (e.g., sodium-[bis (2-ethyl-hexyl) sulfosuccinate] or a functional equivalent) in a densified CO₂ continuous phase 630. The PFPE phosphate surfactant is composed of a phosphate headgroup 602 and a PFPE tail 604. The AOT co-surfactant 612 is composed of a sulfonic acid or sulfonate head group 608 and a di-alkyl tail 610. The PFPE phosphate head groups 602 and AOT head groups 608 align in a reactive reverse micelle 620 or reactive aggregate 620 thereby forming the reactive core 614 of the reverse micelle 620. The PFPE tail 604 and AOT tail 610 of the respective surfactant 606 and co-surfactant 612 provide for the solubility in the densified fluid phase 630. The reactive reverse micelles 620 or reactive aggregates 620 react with residues 650 on a substrate 600 surface yielding chemically modified residues 655 that are removed or separated from the substrate 600 surface. Depending on resulting state (e.g., polarity, charge, oxidation state, etc.), the modified residues 655 may remain in the densified fluid phase 630 or may reside within the inner polar core 614 of the reactive reverse micelles 620. The reactive cleaning fluid is maintained at a temperature that ensures a density (ρ) in the fluid medium above the critical density (ρ_{c}) for pure CO₂.

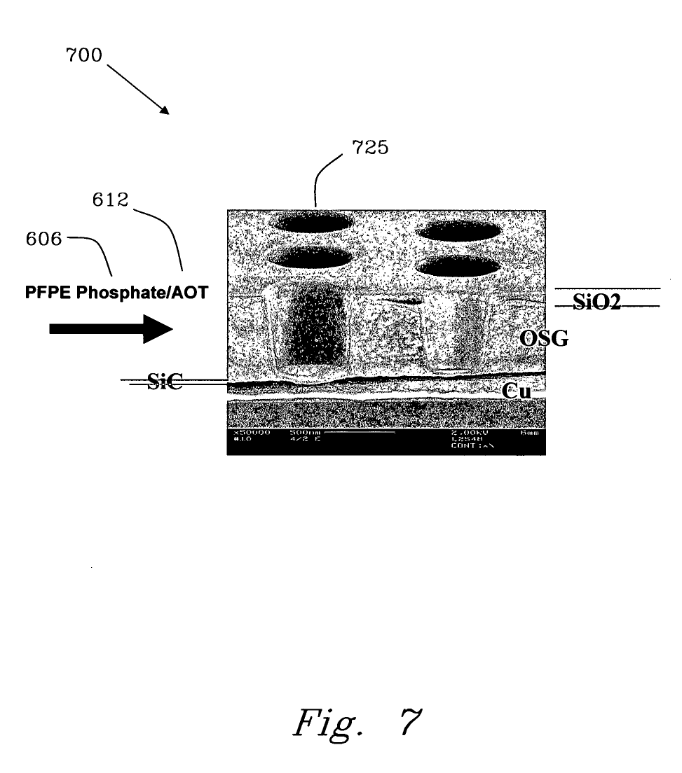

Experimental. A 30 mL mixing vessel 420 was charged with 0.4 mL (1.3%) perfluoro-poly-ether (PFPE) phosphate acid surfactant 606 (Solvay Solexis, Inc., Thorofare, N.J. 08086), 0.15 g (0.5%) of sodium AOT sulfonate co-surfactant 612 (Aldrich Chemical Company, Milwaukee, Wis. 53201), and 25 μL de-ionized, distilled H₂O (0.1%) 614. As an alternative, ammonium AOT sulfonate co-surfactant may be substituted for sodium AOT 606. Solid constituent materials (e.g, surfactants) were added to the bottom vessel section 404 of the mixing vessel 420; liquid constituents (e.g., H₂O) were subsequently added. The bottom vessel section 404 was subsequently capped with the top vessel section 402 forming the mixing chamber 408. The sapphire window 410 was inserted into the upper vessel 402 and the vessel clamp 412 and clamping ring 413 were secured in place thereby effecting a pressure seal in the mixing vessel 420. The mixing vessel 420 was then charged with densified CO₂ 630 via the inlet port 416 and the multi-component fluid was allowed to intermix for about 5 to 10 minutes. The cleaning vessel 440 was also pre-loaded with a commercially processed OSG “no barrier open” (NBO) test wafer coupon 700 (FIG. 7) having dimensions in the range from 1 to 1.75 inches on a side and comprising a series of 1 μm pattern vias 725. Thickness of the wafer 700 was about 725 μm, an industry standard. The cleaning vessel 440 was charged with pure densified CO₂ 630 via the inlet port 452. Transfer of the reactive cleaning fluid into the mixing vessel 420 was effected via opening of a two-way straight valve 540 in pressure connection with the cleaning vessel 440 thereby initiating flow through the restrictor 555. Cleaning occurs preferably in a time below about 15 minutes per wafer on average, and more preferably in about 5 minutes or less. In the instant case, the wafer coupon 700 had a contact time tᵣ in the densified reactive cleaning fluid of about 5 minutes.

Temperature in the cleaning vessel 440 was maintained at about 20° C. to 25° C. with a pressure of 2900 psi thereby maintaining a density of the fluid mixture above the critical density for the bulk continuous CO₂ fluid (about 0.47 g/cc) 630. A rinsing fluid comprising pure densified CO₂ fluid was subsequently introduced to the cleaning vessel 440 through the rinsing loop 520 to aide the removal and recovery of spent reactive cleaning fluid containing the chemically modified substrate residues 655.

Results. FIG. 7 shows an SEM micrograph of the surface of an over-etched OSG NBO test wafer substrate 700 cleaned using the reactive reverse micelle cleaning fluid comprising PFPE phosphate 606/AOT 612/water 614. As shown in FIG. 7, complete removal of crumbs 330, mounds 335, and striations 340 was observed in the post cleaned sample 700 from both the rims and walls of the pattern vias 725.

### EXAMPLE 2

### Reverse Micelle System Comprising Perfluoropolyether Ammonium Carboxylate Surfactant/Hydroxylamine/Water

### Residue Cleaning System

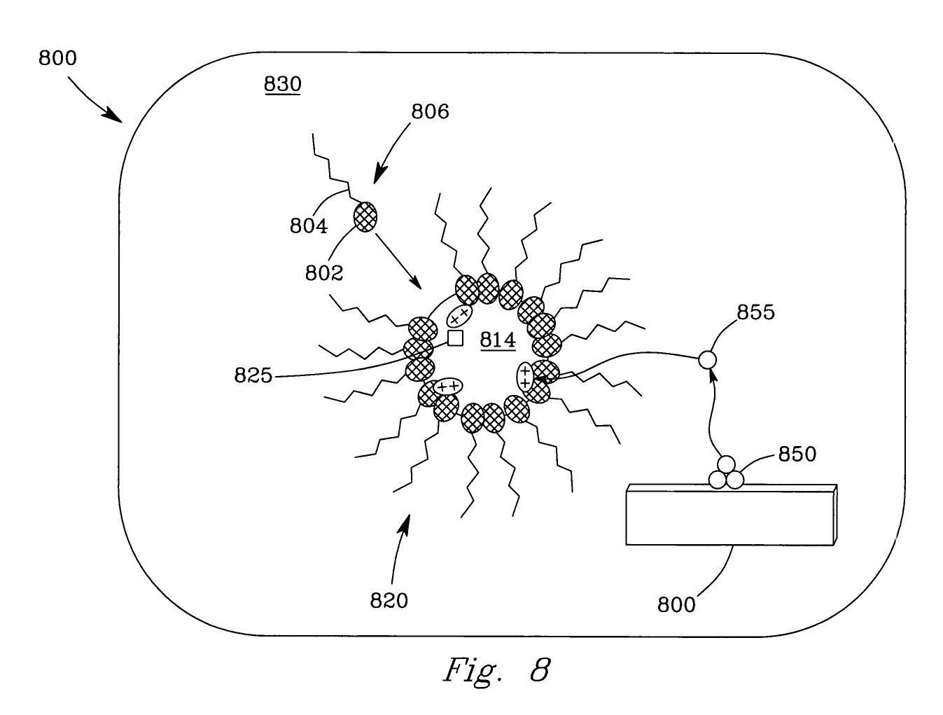

FIG. 8 illustrates a reactive micelle system according to a second embodiment of the present invention. Illustrated is a PFPE-ammonium carboxylate/hydroxylamine system for removing etch and non-metal residues 850 found to be tenacious and problematic residues for semiconductor substrate and wafer surface processing.

The system of the instant embodiment comprises reactive reverse micelles 820 or reactive macro-molecular aggregates 820 comprising a fluorinated reverse micelle-forming surfactant, perfluoro-poly-ether (PFPE) ammonium carboxylate 806, in a densified CO₂ phase 830. The surfactant 806 comprises a carboxylate headgroup 802 and a perfluoro-poly-ether (PFPE) tail 804. The carboxylate headgroups 802 align in close proximity to surround and form the inner polar core 814 of the aggregate 820. The PFPE tail 804 provides solubility in the densified liquid phase 830.

Reactive agents 825 of the instant embodiment are preferably selected from the hydroxylamine class of compounds, hydroxylamine being representative, but not exclusive. Alternatives are preferably selected from the alkanolamine class of compounds, ethanolamine being representative, but not exclusive. The reactive agents 825 in the polar core 814 of the reactive aggregrates 820 react with the residues 850 on a substrate 800 surface chemically modifying them and removing them. Depending on state, the modified residues 855 may reside within the inner polar core 814 of the reactive reverse micelles 620 or alternatively in the densified fluid 830.

The instant system has the added benefit of not generating troublesome particulate residues. The ammonium (NH₄⁺) counterion as a constituent of the PFPE carboxylate 806 is more easily rinsed from a wafer surface 800 than is sodium ion (Na⁺) associated with the surfactant described in Example 1. Concentration of added modifiers (surfactants, co-surfactants, chemical agents, etc.) is preferably below about 30% by volume in the reactive cleaning fluid and more preferably below 2 to 5% by volume for waste minimization, recovery, and/or handling purposes.

Experimental. The PFPE ammonium carboxylate surfactant 806 was prepared for use by chemically derivatizing a pre-surfactant PFPE carboxylic acid surfactant also known as Fluorolink 7004™ available commercially (Solvay Solexis, Inc., Thorofare, N.J. 08086) using ammonium hydroxide available commercially (Aldrich Chemical Company, Milwaukee, Wis. 53201) and a molar excess of fluoro-di-chloro-ethane also known as Freon-113™ available commercially (Alpha-Aesar, Ward Hill, Mass. 01835). Approximately 30 mL of the Fluorolink 7004 ™ pre-surfactant was mixed in a large beaker under nitrogen gas cover with 20 mL of 25% (by volume in water) ammonium hydroxide, immediately generating a solid paste. The paste was dissolved by addition of about 120 mL of Freon-113™ to the beaker and mixing to a clear solution. The liquid was dried under a nitrogen (N₂) gas purge and cover for approximately one week thereby generating the final PFPE ammonium carboxylate surfactant 806 solid.

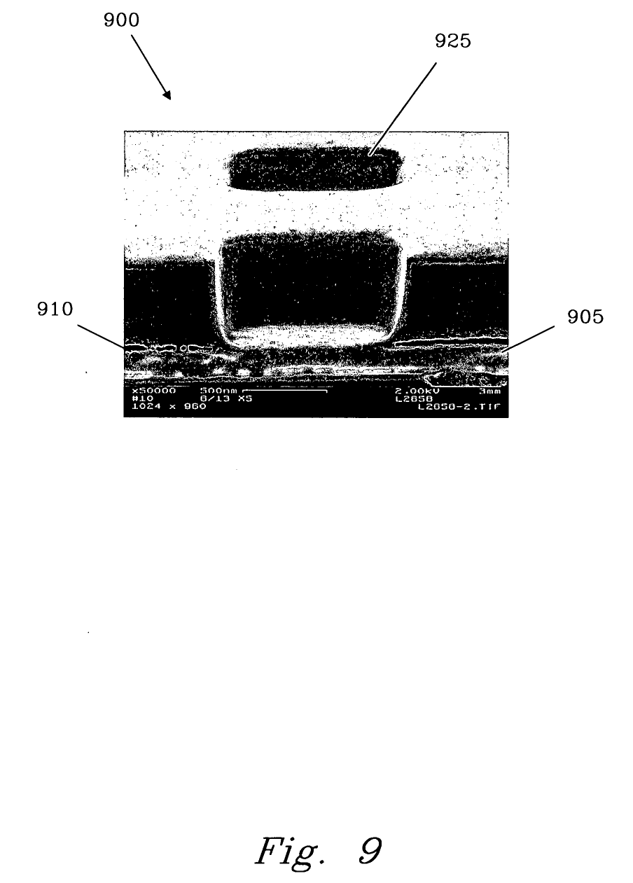

The 30 mL mixing vessel 420 was charged with 1 g (3.3%) PFPE ammonium carboxylate 806, 32 uL of a 50% hydroxylamine solution (Aldrich Chemical Co., Milwaukee, Wis. 53201) 825 or alternatively 38 μL of a 99% ethanolamine solution 806. The vessel 420 was charged with pure densified CO₂ 830 at a temperature of about 20° C. to 25° C. and a pressure of 2900 psi and contents were intermixed for a period of from about 5 to 10 minutes thereby forming the reactive cleaning fluid. The 500 μL cleaning vessel 440 was also pre-loaded with a commercially processed OSG NBO test wafer 900 (FIG. 9) having dimensions in the range from 1.0 inches to 1.75 inches on a side and further comprising a series of 1 μm pattern vias 925, a base layer 905 of Cu, and a stop layer 910 of SiC. Thickness of the wafer coupon 900 was an industry standard, about 725 um. The substrate 900 surface was contaminated with quantities of etch and non-metal residues 816. The cleaning vessel 440 was charged with pure densified CO₂ 830 at a temperature of about 20° C. to 25° C. and pressure of about 2900 psi via the inlet port 452 to maintain density in the fluid 830 above the critical density of pure CO₂ (0.47 g/cc). Transfer of the reactive cleaning fluid into the mixing vessel 420 was effected via opening of a two-way straight valve 540 in pressure connection with the cleaning vessel 440 thereby initiating flow through the restrictor 555. Cleaning occurs preferably in a time below about 15 minutes per wafer on average, and more preferably in about 5 minutes or less. In the instant case, the wafer coupon 900 had a contact time tr in the densified reactive cleaning fluid of about 5 minutes. Temperature in the cleaning vessel 440 was maintained at about 20° C. to 25° C. with a pressure of 2900 psi to maintain a density in the fluid mixture above the critical density for the bulk continuous CO₂ fluid (about 0.47 g/cc) 830. A rinsing fluid preferably containing pure densified CO₂ fluid 830 was subsequently introduced to the cleaning vessel 440 through the rinsing loop 520 to remove the spent reactive cleaning fluid containing the chemically modified substrate residues 855.

Results. FIG. 9 shows an SEM micrograph for the cleaned surface of the over-etched OSG “no barrier open” (NBO) test coupon 900. As shown in FIG. 9, no etch residues (e.g., crumbs or striations) were observed on the rims and/or walls of the pattern via 925 following cleaning, showing the successful removal of residues from the wafer 900 surface. Maximum removal of residues was accomplished in this system in about 5 minutes or less on average.

The instant embodiment has been shown to be a reactive system given that chemical agent(s) in the densified medium react and chemically modify residues 816 removing them from the surface. Hydroxylamine 825, for example, is corrosive with many plastics, organic acids, and esters and serves to hydrolyze Si—X bonds from the surface substrates. Hydroxylamine 825 may also produce hydroxide that chemically aides in the cleaning process. Results show the reactive agents 825 of the instant system in combination effectively remove surface etch residues 855 to a commercial level of clean satisfactory for semiconductor processing. Overall, the system exhibits attractive commercial processing attributes, including low quantities of modifiers (less than about 3 to 5% by volume total), relatively low volatility lending to ease of recovery of system constituents, low toxicity, minimal CD change, and high speed cleaning (less than about 5 minutes on average).

It should be noted that the presence of a reverse micelle forming surfactant 806 is not sufficient or effective alone in removing residues 850. Further, hydroxylamine is not soluble in the neat densified CO₂. It is the combination of constituents in the system that effects removal of residues 850. Direct contact with, and reaction between, the reactive reverse micelles 820, the reactive chemical agent(s) 825 and residues 855 of interest is critical.

### EXAMPLE 3

### Reverse Micelle System Comprising Fluorocarbon Phosphate Acid Surfactant/Alkyl Sulfonate Co-Surfactant/Benzotriazole (BTA)/Water

### Metal Residue Cleaning System

In a third embodiment of the present invention, a surfactant/co-surfactant/corrosion inhibitor/water system has been shown to be effective for removing metal residues (e.g., Cu, Fe, Al, etc.) found to be tenacious and problematic residues for semiconductor (e.g., silicon) substrate and wafer surface processing. The instant system has very attractive attributes for commercial processing including very low quantities of modifiers, very low volatility, ease of fluid recovery, low toxicity, minimal CD changes, and high speed cleaning (less than about 5 minutes per wafer on average).

Testing was conducted on a porous low-K dielectric (LKD) “barrier-open” (BO) wafer coupon 600 (e.g., LKD BO) having significant levels of copper residue 650. The system of the present embodiment is composed of reactive reverse micelle(s) 620 or reactive aggregates 620 comprising a perfluoro-poly-ether (PFPE) phosphate surfactant 606 having a phosphate headgroup 602 and a PFPE tail 604 and a [bis (2-ethyl-hexyl) sulfosuccinate] (e.g., sodium AOT acid sulfonate) co-surfactant 612 having a sulfonic acid or sulfonate headgroup 608 and a dialkyl (e.g., 2-ethyl-hexyl) tail 610, all present in a densified CO₂ continuous phase 630. In the present embodiment, a corrosion inhibitor was also added to the fluid system to passivate the base metal layer (e.g., Cu) of the BO substrate 600. The phosphate head groups 602 and/or sulfonic head groups 608 react with metal residues 650 to yield chemically modified surface residues 655 that are removed from the substrate 600 and may reside in the reverse-micelle core 614 and/or in the densified fluid 630. For example, chemical oxidation of metal residues 650 such as Cu(0) and/or Cu(I) that yield chemically modified residues 655 such as Cu(I) and/or Cu(II), when removed from the surface of the substrate 600 may migrate to the inner micellar core 614 where head groups 602 and 608 in the reactive aggregate 620 can bind or complex with the modified residues 655.

Experimental. A 30 mL mixing vessel 420 was charged with 0.4 mL (1.3%) perfluoro-poly-ether (PFPE) phosphate acid surfactant 606 (Solvay Solexis, Inc., Thorofare, N.J. 08086), 0.15 g (0.5%) of sodium AOT sulfonate co-surfactant 612 (Aldrich Chemical Company, Milwaukee, Wis. 53201), 25 μL de-ionized, distilled H₂O (0.1%), and 5 mg 99% BTA (Aldrich Chemical Co., Milwaukee, Wis. 53201), or alternatively 0.023 g (0.1%) 95% catechol (Aldrich Chemical Co., Milwaukee, Wis. 53201). As an alternative, ammonium AOT sulfonate co-surfactant may be substituted for the sodium AOT 606. Solid constituent materials (e.g., surfactant) were added to the bottom vessel section 404; liquid constituents (e.g., H₂O) were subsequently added. The bottom vessel section 404 was subsequently capped with the top vessel section 402 forming the mixing chamber 408. The sapphire window 410 was inserted into the upper vessel portion 402 and the vessel clamp 412 and clamping ring 413 were secured in place on the mixing vessel 420 thereby effecting a pressure seal in the vessel 420. The vessel 420 was then charged with densified CO₂ 630 via the inlet port 416 and the multi-component fluid was allowed to intermix for about 5 to 10 minutes. The cleaning vessel 440 was also pre-loaded with a commercially processed test wafer 100 of a barrier-open (BO) type having dimensions in the range from 1 to 1.75 inches on a side. Thickness was an industry standard of about 725 μm. The cleaning vessel 440 was charged with pure densified CO₂ 630 via the inlet port 452. Transfer of the reactive cleaning fluid into the mixing vessel 420 was effected by opening a two-way straight valve 530 in pressure connection with the cleaning vessel 440 thereby initiating flow through the restrictor 555. Cleaning occurs preferably in a time below about 15 minutes per wafer on average, and more preferably in about 5 minutes or less. In the instant case, the wafer coupon 600 had a contact time tᵣ in the densified reactive cleaning fluid of about 5 minutes. Temperature in the cleaning vessel 440 was maintained at about 20° C. to 25° C. with a pressure of 2900 psi to ensure a density in the reactive cleaning mixture or fluid above the critical density for CO₂ of about 0.47 g/cc.

A rinsing fluid comprising about 5% iPrOH by volume in the densified CO₂ fluid was preferably introduced to the cleaning vessel following residue removal to aide the recovery of the spent cleaning fluid containing modified residues 655 from the wafer surface 600.

Results. Table 1 presents XPS analysis results for residual copper for an OSG BO test wafer coupon 600 following cleaning using the PFPE phosphate/alkyl sulfonate/BTA/water system including rinsing with a rinsing fluid comprising 5% iPrOH in densified CO₂.

TABLE 1
XPS surface analysis results for residual copper for a
OSG BO wafer coupon following cleaning with a reactive
reverse-micelle system comprising PFPE phosphate/AOT/BTA/water
including a rinse with 5% iPrOH in densified CO₂,
according to a third embodiment of the present invention.

| | | XPS Surface, Cu |
|---|---|---|
| Clean Type | Wafer Type | (atoms/cm²) |
| Untreated | OSG BO | 1.0E+13 |
| Reactive Reverse | OSG BO | 4.0E+11 |
| Micelle-Treated | | |

A residue concentration below about 2×10¹² atoms/cm² is considered viable for commercial wafer processing by current semiconductor industry standards. As shown in Table 1, copper residues on the test substrate 600 were reduced to about 4×10¹¹ atoms/cm², substantially below the industry standard for metal residue cleaning showing the present system to be efficacious at removing metal residues 650. Maximum removal of metal residues 650 was accomplished in this system in about 5 minutes or less on average. In addition, results showed the base metal layer (e.g., Cu) of the BO substrate 600 was preserved by addition of the corrosion inhibitor as a modifier in the instant system.

The instant system has been shown to be a reactive system given that chemical agent(s) in the densified medium react with substrate residues chemically modifying and removing them from the surface. Results further show the reactive constituents of the instant system in combination effectively remove surface residues to a commercial level of clean, including preservation of the substrate layers, satisfactory for semiconductor processing. Concentration of added modifiers including surfactants, water, hydroxylamine, etc. is preferably below about 30% by volume in the reactive cleaning fluid and more preferably below about 2 to 5% by volume for waste minimization and/or handling purposes.

Again, it should be noted that the presence of a reverse micelle forming surfactant is not sufficient or effective in removing residues alone. It is the combination of constituents in the system that effects removal of residues. Direct contact with, and reaction between, the reactive reverse micelles, the reactive chemical agent(s) and the residues of interest is critical.

### EXAMPLE 4

### Reverse Micelle System Comprising Perfluoropolyether Carboxylate Surfactant/Hydroxylamine/Water

### Metal Residue Cleaning System

In a fourth embodiment of the present invention, cleaning and removal of tenacious metal residues (e.g., Cu, Al, Fe, etc.) has been demonstrated using a perfluoro-poly-ether (PFPE) ammonium carboxylate surfactant/hydroxylamine/water system, as detailed herein below.

The system of the instant embodiment comprises a fluorinated hydrocarbon surfactant 806 of PFPE-ammonium carboxylate 806 having a carboxylate headgroup 802 and a PFPE tail 804 in a densified CO₂ phase 830. Again, the NH₄⁺ counterion for the salt is preferred as it is more easily rinsed from the wafer surface than is Na⁺ ion. The fluorinated hydrocarbon surfactant 806 forms macro-molecular reactive aggregates 820 or reactive reverse micelles 820 in the densified CO₂ medium 830 wherein the carboxylate headgroups 802 align in close proximity to surround and form the inner polar core 814 of the reactive aggregates 820. The PFPE tail 804 provides solubility in the densifed fluid 830. Dimensions of the inner core 814 and reactive aggregates 820 are defined primarily by the presence of the trace quantities of reactive constituents or agents 825 residing within the polar core 814. Depending on state, reactive agents 825 may also reside within the bulk densified fluid 830.

In the instant example, reactive agents 825 present in the polar core 814 of the reactive aggregrates 820 react with metal residues 850 of interest yielding chemically modified residues 855 which are removed from the substrate surface 800. Depending on the resulting state, modified residues 855 may reside in the polar reverse-micelle core 814 or alternatively in the densified fluid 830. Reactive agents 825 of the instant embodiment are preferably selected from the amine class of compounds, hydroxylamine being representative, but not exclusive. Alternatives are preferably selected from the alkanolamine class of compounds, ethanolamine being representative, but not exclusive. Concentration of added modifiers (surfactants, co-surfactants, chemical agents, etc.) is preferably below about 30% by volume in the reactive cleaning fluid and more preferably below 2 to 5% by volume for waste minimization, recovery, and/or handling purposes.

Experimental. The PFPE ammonium carboxylate surfactant 806 was prepared for use as in Example 2 above. The 30 mL mixing vessel 420 was charged with 1 g (3.3%) PFPE ammonium carboxylate surfactant 806, 32 uL of a 50% hydroxylamine solution (Aldrich Chemical Co., Milwaukee, Wis. 53201) 825 or alternatively 38 μL of a 99% ethanolamine solution. No corrosion inhibitor was added in the current system. Contents of the vessel 420 were intermixed for a period of from 5-10 minutes by charging with pure densified CO₂ 830 at a temperature of about 20° C. to 25° C. and pressure of 2900 psi thereby forming the reactive cleaning fluid. The 500 pL cleaning vessel 440 was also pre-loaded with an over-etched commercially processed LKD “barrier open” (BO) test wafer 100 (e.g., LKD BO) having dimensions in the range from 1.0 inches to 1.75 inches on a side. The surface was contaminated with quantities of metal residues 850 (e.g., Cu). Thickness of the wafer coupon 800 was an industry standard of about 725 μm. The cleaning vessel 440 was charged with pure densified CO₂ 830 at a temperature of about 20° C. to 25° C. and pressure of 2900 psi via the inlet port 452 to maintain density in the fluid above the critical density of pure CO₂ (0.47 g/cc). Transfer of the reactive cleaning fluid into the mixing vessel 420 was effected via opening of a two-way straight valve 530 in pressure connection with the cleaning vessel 440 thereby initiating flow through the restrictor 555. The wafer coupon 800 had a contact time tᵣ in the densified reactive cleaning fluid of about 5 minutes or less. Temperature in the cleaning vessel 440 was maintained at about 20° C. to 25° C. with a pressure of 2900 psi to ensure a density in the fluid mixture above the critical density for CO₂ of about 0.47 g/cc. The wafer substrate 800 was rinsed from 2 to 5 times with a rinsing fluid comprising the densified CO₂ fluid to ensure complete removal of the reactive cleaning fluid containing the modified residues 855 cleaned from the wafer surface 800.

Results. Table 2 presents XPS analysis results for residual copper for a LKD BO (“barrier open”) test coupon 800 cleaned using the PFPE ammonium carboxylate/hydroxylamine system.

TABLE 2
XPS surface analysis for residual copper of a LKD BO
wafer coupon following cleaning with a reactive reverse-micelle
system comprising PFPE-ammonium carboxylate/hydroxylamine
according to a fourth embodiment of the present invention.

| | | XPS Surface, Cu |
|---|---|---|
| Clean Type | Wafer Type | (atoms/cm²) |
| Untreated | LKD BO | 6.4E+12 |
| Reactive Reverse | LKD BO | 1.0E+12 |
| Micelle-Treated | | |

A residue concentration below about 2×10¹² atoms/cm² is considered viable for commercial wafer processing by current semiconductor industry standards. As shown in Table 2, copper residues in the test substrate were reduced to about 1×10¹² atoms/cm², evidence of the viability of the instant embodiment for commercial wafer processing. As in Example 3, results further showed the base metal layer (e.g., Cu) of the BO substrate 800 was preserved by addition of the corrosion inhibitor as a modifier in the instant system. Maximum removal of metal residues was accomplished in about 5 minutes or less on average.

The instant system has been shown to be a reactive system given that chemical agent(s) in the densified medium react with substrate residues chemically modifying and removing them from the surface. Results further show the reactive constituents of the instant system in combination effectively remove surface residues to a commercial level of clean, including preservation of the substrate layers, satisfactory for semiconductor processing. Results further show a corrosion inhibitor is not required to achieve an effective level of cleaning. Overall, results show this system exhibits attractive commercial processing attributes, including low quantities of modifiers, relatively low volatility of constituents lending to ease of recovery from the bulk fluid, low toxicity, minimal CD change, and high speed cleaning (about 5 minutes on average or less).

As with the other system embodiments presented herein, the presence of a reverse micelle forming surfactant is not sufficient or effective in removing residues alone. It is the combination of constituents in the system that effects removal of residues. Direct contact with, and reaction between, the residues of interest, the reactive reverse micelles, and the reactive chemical agent(s) is critical.

While the preferred embodiment of the present invention has been shown and described, it will be apparent to those skilled in the art that many changes and modifications may be made without departing from the invention in its broader aspects. The appended claims are therefore intended to cover all such changes and modifications as fall within the spirit and scope of the invention.

1. A process for removing residues from a semiconductor substrate, comprising the steps:
providing a densified fluid wherein said fluid is a gas at standard temperature and pressure and wherein the density of the fluid is above the critical density;
providing a cleaning component;
intermixing said densified fluid and said cleaning component forming a reactive cleaning fluid comprising reactive reverse-micelle(s) or reactive aggregates; and
contacting a residue on a substrate with said reactive cleaning fluid whereby said residue is chemically modified and removed from said substrate.

2. The process according to claim 1, wherein said cleaning component comprises at least one member selected from the group consisting of reverse micelle-forming surfactants, reverse micelle-forming co-surfactants, reactive reverse micelle-forming surfactants or reactive reverse micelle-forming co-surfactants, reactive chemical agents, and combinations thereof.

3. The process according to claim 2, wherein said co-surfactants comprise alkyl acid phosphate, alkyl acid sulfonate, alkyl alcohol, substituted alkyl alcohol, perfluoroalkyl alcohol, dialkyl sulfosuccinate, bis-(2-ethyl-hexyl) sulfosuccinate, AOT, sodium AOT, ammonium AOT, derivatives thereof, salts thereof, or combinations thereof.

4. The process according to claim 2, wherein said co-surfactants comprise a non-CO₂-philic surfactant and a CO₂-philic surfactant.

5. The process according to claim 1, further comprising the step of rinsing said substrate with a densified rinsing fluid comprising up to about 30% modifiers by volume.

6. The process according to claim 5, wherein said rinsing fluid is a pure densified fluid.

7. The process according to claim 5, wherein said rinsing fluid is a mixture of densified CO₂ and a modifier selected from the group consisting of isopropyl alcohol, H₂O, methanol, ethanol, or combinations thereof.

8. The process according to claim 7, wherein said rinsing fluid comprises up to about 15% by volume isopropyl alcohol.

9. The process of claim 1, wherein said densified fluid is a liquid with a temperature from about 20° C. to about 25° C., a pressure from about 850 psi to about 3000 psi, and a density above a critical density for the densified fluid.

10. The process according to claim 1, wherein said chemical modification of said residue comprises at least one reaction selected from the group consisting of chemical, oxidation, reduction, molecular weight reduction, fragment cracking, exchange, association, dissociation, or combinations thereof whereby dissolution, solubilization, complexation, or binding of residues occurs whereby said residues are removed from said substrate.

11. The process according to claim 1, wherein said reactive cleaning fluid has a reduced density in the range from about 1 to about 3.

12. The process according to claim 1, wherein said reactive cleaning fluid has a temperature and pressure above the critical temperature and critical pressure of said densified fluid.

13. The process according to claim 1, wherein said densified fluid is a member selected from the group consisting of carbon dioxide, chlorodifluoromethane, ethane, ethylene, propane, butane, sulfur hexafluoride, ammonia, and combinations thereof.

14. The process according to claim 1, wherein said reverse micelle forming surfactant is a member selected from the group consisting of CO₂-philic, anionic, cationic, non-ionic, zwitterionic, and combinations thereof.

15. The process according to claim 14, wherein said anionic reverse-micelle forming surfactant is selected from the group consisting of PFPE surfactants, PFPE carboxylates, PFPE sulfonates, PFPE phosphates, alkyl sulfonates, bis-(2-ethyl-hexyl) sulfosuccinates, sodium bis-(2-ethyl-hexyl) sulfosuccinate, ammonium bis-(2-ethyl-hexyl) sulfosuccinate, fluorocarbon carboxylates, fluorocarbon phosphates, fluorocarbon sulfonates, and combinations thereof.

16. The process according to claim 14, wherein said cationic reverse-micelle forming surfactant is selected from the tetraoctylammonium fluoride class of compounds.

17. The process according to claim 14, wherein said non-ionic reverse-micelle forming surfactant is selected from the poly-ethyleneoxide-dodecyl-ether class of compounds.

18. The process according to claim 14, wherein said zwitterionic reverse-micelle forming surfactant is selected from the alpha-phosphatidyl-choline class of compounds.

19. The process of claim 1, wherein said reactive chemical agent is selected from the group consisting of mineral acids, fluoride-containing compounds and acids, organic acids, oxygen-containing compounds, amines, alkanolamines, peroxides, chelates, ammonia, and combinations thereof.

20. The process according to claim 19, wherein said mineral acids are selected from the group consisting of HCl, H₂SO₄, H₃PO₄, HNO₃, HSO₄⁻, H₂PO₄, HPO₄²⁻, phosphate acids, acid sulfonates, dissolution products thereof, salts thereof, and combinations thereof.

21. The process according to claim 19, wherein said fluoride-containing compounds and acids are selected from the group consisting of F₂, HF, dilute HF, ultra-dilute HF, and combinations thereof.

22. The process according to claim 19, wherein said organic acids are selected from the group consisting of sulfonic acids, phosphate acids, phosphate esters or their salts, substituted derivatives thereof, and combinations thereof.

23. The process according to claim 19, wherein said oxygen-containing compounds are selected from the group consisting of O₂, ozone, functional or reactive equivalents, and combinations thereof.

24. The process according to claim 19, wherein said alkanolamine is an ethanolamine.

25. The process according to claim 19, wherein said amine is hydroxylamine.

26. The process according to claim 19, wherein said chelate is a member selected from the group consisting of pentanediones; 2,4 pentanediones; phenanthrolines; 1,10 phenanthroline; EDTA, sodium EDTA, oxalic acid, or combinations thereof.

27. The process according to claim 19, wherein said peroxides are selected from the group consisting of organic peroxides, alkyl peroxides, t-butyl peroxides, hydrogen peroxide, substituted derivatives, and combinations thereof.

28. The process in accordance with claim 1, wherein said reactive cleaning fluid comprises up to about 30% by volume of reactive reagents and/or modifiers.

29. The process in accordance with claim 28, wherein said reactive cleaning fluid comprises about 2 to 5% modifiers by volume including PFPE acid phosphate, AOT, H₂O, or combinations thereof.

30. The process in accordance with claim 28, wherein said reactive cleaning fluid comprises about 3 to 5% modifiers by volume including PFPE carboxylate, alkanolamines, hydroxylamine, H₂O, or combinations thereof.

31. The process in accordance with claim 28, wherein said reactive cleaning fluid further comprises a corrosion inhibitor having a concentration in the range from about 0.1% to about 1% by volume.

32. The process in accordance with claim 31, wherein said corrosion inhibitor is selected from the group consisting of benzotriazoles; 1,2,3-benzotriazole; catechols; catechol; 1,2-di-hydroxy-benzene; 2-(3,4-di-hydroxy-phenyl)-3,4-di-hydro-2H-1-benzopyran-3,5,7-triol, substituted derivatives thereof, and combinations thereof.

33. The process according to claim 28, wherein said reactive cleaning fluid further comprises about 5% modifiers by volume including PFPE carboxylates, amines, alkylamines, hydroxylamine, benzotriazoles, catechols, and combinations thereof.

34. The process of claim 1, wherein said contacting comprises a contact time with said reactive cleaning fluid of about 15 minutes.

35. The process of claim 1, wherein said contacting comprises a contact time with said reactive cleaning fluid of less than about 5 minutes.

36. The process of claim 1, wherein said residue is selected from the group consisting of organic residues, metal residues, etch residues, non-metal residues, polymeric residues, and combinations thereof.

37. The process of claim 1, wherein said residue is a transition metal.

38. The process of claim 1, wherein said residue is selected from the group consisting of Cu, Al, Fe, Ta, and combinations thereof.

39. The process of claim 1, wherein said reactive cleaning fluid has a temperature in the range from about 20° C. to about 25° C., a pressure in the range from about 850 psi to about 3000 psi, and a fluid density above the critical density of the densified fluid.

40. The process of claim 1, wherein contacting of said residue with said reactive cleaning fluid is preceeded by etching of said substrate.

41. The process of claim 1, wherein said process is applied in manufacturing of a semiconductor substrate.

42. The process of claim 41, wherein manufacturing of said substrate or wafer further comprises a processing step selected from the group consisting of etching, residue removing, cleaning, transferring, rinsing, depositing, and combinations thereof.

43. The process of claim 42, wherein said transferring comprises moving said substrate or wafer with a transfer system or device during manufacturing of said wafer.

44. The process of claim 42, wherein depositing comprises deposition of a material to said substrate or wafer selected from the group consisting of metals, non-metals, silicon, films and layers thereof, or combinations thereof.

45. The process of claim 1, wherein contacting of said residue with said reactive cleaning fluid comprises applying said fluids in conjunction with a fluid delivery system or device.

46. An apparatus, comprising:
a cleaning vessel or chamber operably disposed to receive a semiconductor substrate or wafer and a reactive cleaning fluid therein, said cleaning fluid comprising reactive reverse-micelle(s) or reactive aggregates formed by intermixing of a densified fluid and a cleaning component, wherein said densified fluid is a gas at standard temperature and pressure and the density of the densified fluid is above the critical density for said densified fluid;
delivery means for applying said reactive fluid to said wafer in said vessel or chamber; and
whereby when contacting said residue on said substrate or wafer in said chamber or vessel with said reactive cleaning fluid said residue is chemically modified and removed from said wafer or substrate.

47. The apparatus of claim 46, wherein said cleaning component comprises at least one member selected from the group consisting of reverse micelle-forming surfactants, reverse micelle-forming co-surfactants, reactive reverse micelle-forming surfactants or reactive reverse micelle-forming co-surfactants, reactive chemical agents, and combinations thereof.

48. The apparatus of claim 46, wherein said delivery means for applying said reactive cleaning fluid is a delivery system or device.

49. The apparatus of claim 48, wherein said delivery system or device further comprises a pumping system or device for delivering said cleaning fluid.
